(19) United States
(12) Patent Application Publication
(10) Pub. No.: US 2013/0134829 A1
(43) Pub. Date: May 30, 2013

(54) DISK TYPE MEMS RESONATOR

(71) Applicants: Takefumi Saito, Tokyo (JP); Noritoshi Kimura, Tokyo (JP)

(72) Inventors: Takefumi Saito, Tokyo (JP); Noritoshi Kimura, Tokyo (JP)

(73) Assignee: NIHON DEMPA KOGYO CO., LTD., TOKYO (JP)

(21) Appl. No.: 13/814,736

(22) PCT Filed: Jun. 13, 2011
(86) PCT No.: PCT/JP2011/063992

§ 371 Date: Feb. 7, 2013

(30) Foreign Application Priority Data
Aug. 11, 2010 (JP) 2010-180357

(51) Int. Cl. H02N 1/00

(52) U.S. Cl. CPC H02N 1/008
USPC 310/300

(57) ABSTRACT

A variation in a resonance frequency due to variation in dimension accuracy of the supporting structure of the vibrating unit is reduced, and energy loss leaked from the supporting structure is reduced as much as possible. The electrostatic drive disk-type MEMS vibrator includes: a disk type vibrating unit; drive electrodes disposed at a prescribed gap g from the peripheral portion of the disk type vibrating unit and disposed at both sides of the vibrating unit so as to face each other; a unit for applying alternating current bias voltages of the same phase to the drive electrodes; and detection units that obtain outputs corresponding to the capacitance between the disk type vibrating unit and the drive electrodes. The disk type vibrating unit is supported by a pillar-shaped supporting structure disposed upright at the center of the disk and a transverse cross-sectional shape of the supporting structure is non-circular.

### TECHNICAL FIELD

This disclosure relates to a disk type resonator (a resonator) fabricated by MEMS. Especially, the disclosure relates to a supporting structure of a vibrating unit of the disk type resonator.

### BACKGROUND ART

The conventional disk type MEMS resonator has a configuration similar to the disk type MEMS resonator according to the disclosure as illustrated in FIG. 1. The conventional disk type MEMS resonator includes a disk-shaped vibrating unit (a disk) 1, drive electrodes 2, 2, a unit (an alternating current power source) 2a, and detection units (a detection electrode 3 and a detector 3a). The drive electrodes 2, 2 are disposed at both sides of this vibrating unit 1 having a predetermined gap g with respect to an outer peripheral portion 1a of the vibrating unit 1. The drive electrodes 2, 2 are disposed opposed to each other. The unit 2a applies an alternating current bias voltage with the same phase to the drive electrodes 2, 2. The detection units (the detection electrode 3 and the detector 3a) obtain an output corresponding to an electrostatic capacitance between the vibrating unit 1 and the drive electrodes 2, 2. The vibrating unit 1 includes a center O and a supporting structure 1b. As illustrated in FIG. 6, the supporting structure 1b has a circular cross section, a pillar shape and supports the vibrating unit 1 at the center O.

This disk type resonator (the resonator) is fabricated by forming a silicon film on a silicon substrate by Micro Electro Mechanical Systems (MEMS).

Patent Literature 1: Japanese Unexamined Patent Publication No. 2007-152501

Non-Patent Literature 1: M. A. Abdelmoneum, M. U. Demirci, and C. T.-O. Nguyen, “Stemless wine-glass-mode disk micromechanical resonators,” Proceedings, 16^{th} Int. IEEE Micro Electro Mechanical Systems Conf., Kyoto, Japan, Jan. 19-23, 2003, pp. 698-701

Non-Patent Literature 2: W.-L. Huang, Z. Ren, and C. T.-C. Nguyen, “Nickel vibrating micromechanical disk resonator with solid dielectric capacitive-transducer gap,” Proceedings, 2006 IEEE Int. Frequency Control Symp., Miami, Fla., Jun. 5-7, 2006, pp. 839-847

### SUMMARY OF INVENTION

### Technical Problem

However, as illustrated in FIG. 6, this kind of the conventional disk type MEMS resonator includes a pillar-shaped supporting structure, which supports the vibrating unit (the disk). The pillar-shaped supporting structure has a transverse cross-sectional shape of a circular shape. Therefore, a variation of resonance frequency obtained from the vibrating unit becomes large due to variation of dimension accuracy of the transverse cross section of the pillar-shaped supporting structure. Additionally, energy loss leaked to the supporting structure is large. This cause problems that the predetermined resonance frequency cannot be obtained and a Q factor is drastically reduced.

### Solution to Problem

To solve the above-described problems, a disk type MEMS resonator according to the disclosure includes a supporting structure of a vibrating unit that has a transverse cross-sectional shape of a non-circular cross section. The non-circular cross section is, for example, any of a square shape, a cross shape, a rectangular shape, and an oval shape. This reduces a variation in a resonance frequency due to variation in dimensions of the transverse cross section of the supporting structure, and reduces energy loss leaked from the supporting structure.

Thus, a disk type MEMS resonator according to the disclosure is an electro-static drive disk-type MEMS resonator that includes a disk type vibrating unit, drive electrodes, a unit, and a detection unit. The drive electrodes are disposed opposite to one another. The drive electrodes are disposed at both sides of the vibrating unit having a predetermined gap with respect to an outer peripheral portion of the disk type vibrating unit. The unit is configured to apply an alternating current bias voltage with a same phase to the drive electrodes. The detection unit is configured to obtain an output corresponding to an electrostatic capacitance between the disk type vibrating unit and the drive electrodes. The disk type vibrating unit is supported by a pillar-shaped supporting structure. The supporting structure is disposed upright at the center of the disk. The supporting structure has a transverse cross-sectional shape of a non-circular shape.

In the disclosure, the supporting structure have a transverse cross-sectional shape of the non-circular shape that is a square shape, a cross shape, a rectangular shape, or an oval shape.

In the disclosure, the drive electrodes are disposed symmetrically with respect to the Y-axis on the X-Y plane. Each side of the supporting structure with the transverse cross-sectional shape is constituted to rotate around the Z-axis direction such that an inner angle of the X-axis and the Y-axis becomes 45°.

In the disclosure, the vibrating unit is made of a monocrystalline silicon or a polycrystalline silicon.

In the disclosure, the disk type resonator is fabricated by MEMS.

### Advantageous Effects of Disclosure

A variation in a resonance frequency due to variation in dimensions of the transverse cross section of the supporting structure of the vibrating unit decreases while energy loss leaked from the supporting structure decreases.

### BRIEF DESCRIPTION OF DRAWINGS

FIG. 1 is a conceptual structure diagram of a disk type MEMS resonator according to the disclosure.

FIG. 2 is a perspective view of a vibrating unit and a supporting structure of the disk type MEMS resonator according to the disclosure illustrated in FIG. 1.

FIG. 3 is a graph illustrating a relationship between “a” dimensions of a cross-sectional shape of the supporting structure of the disk type MEMS resonator according to the disclosure and a resonance frequency.

FIG. 4 is a graph illustrating a relative value of a Q factor of the supporting structure of the disk type MEMS resonator with each cross sectional shape according to the disclosure relative to a circular shape model.

FIGS. 5A to 5G are process views illustrating a fabrication process of the disk type MEMS resonator according to the disclosure.

FIG. 6 is a perspective view illustrating a vibrating unit and a supporting structure of the conventional disk type MEMS resonator.

### DESCRIPTIONS OF REFERENCE NUMERAL

R disk type MEMS resonator (resonator)

1 vibrating unit (disk) (resonator structure formation layer)

1a, 1b supporting structure

22 drive electrode

2a alternating current power source

3 detection electrode

3a detection unit

6 semiconductor substrate

7 first insulating film

8 second insulating film

9a˜9d resist film

10 conducting layer

11 sacrifice layer

12 oxidized film

13 oxidized film

### DESCRIPTION OF EMBODIMENTS

### Embodiment

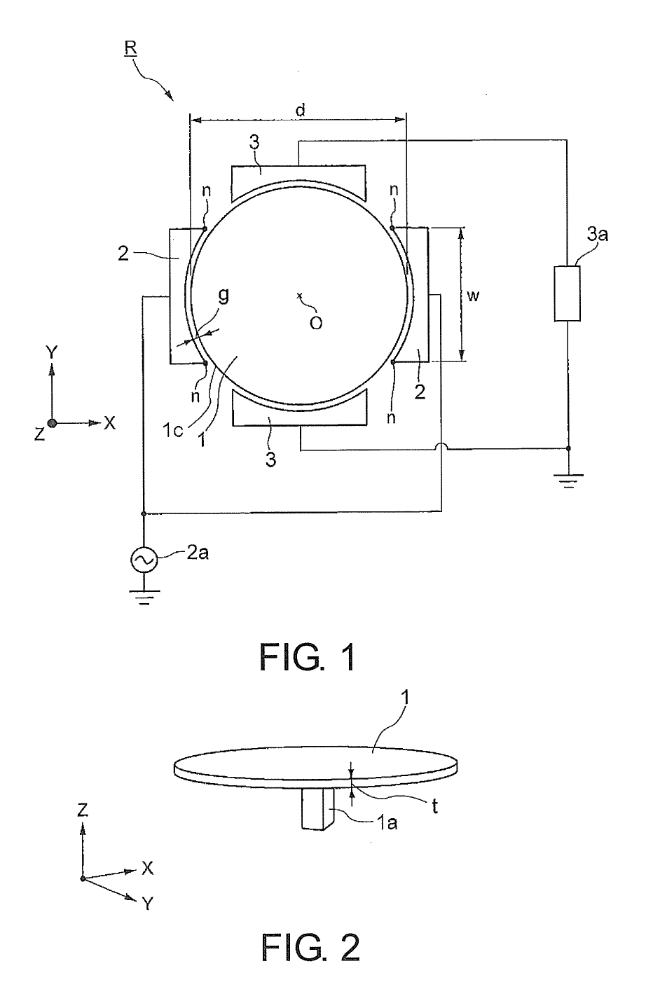

FIG. 1 is a conceptual structure diagram of a disk type MEMS resonator according to the present disclosure.

As illustrated in FIG. 1, a disk type MEMS resonator R according to the disclosure includes a disk-shaped vibrating unit (a disk) 1, a pair of drive electrodes 2, 2, an alternating current power source 2a, a pair of detection electrodes 3, 3, and a detection unit 3a. The disk-shaped vibrating unit 1 is made of an elastic body. The pair of drive electrodes 2, 2 are disposed at both sides of this vibrating unit 1 having a predetermined gap g with respect to an outer peripheral portion of the vibrating unit 1. The pair of drive electrodes 2, 2 are disposed opposite to one another. The alternating current power source 2a applies an alternating current bias voltage with the same phase to the pair of drive electrodes 2, 2. The pair of detection electrodes 3, 3 obtains an output corresponding to an electrostatic capacitance of the gap g between the vibrating unit 1 and the drive electrodes 2, 2. The vibrating unit 1 includes a center O and a supporting structure 1a. As illustrated in FIG. 2, the supporting structure 1a has a pillar shape with a non-circular cross-sectional shape and supports the vibrating unit 1 at the center O. With this disk type MEMS resonator, when an electrical signal of a predetermined frequency is applied from a power source 2a illustrated in FIG. 1 to the drive electrodes 2, 2, the vibrating unit (the disk) 1 vibrates at the above-described frequency in a Wine-Glass-Vibrating-Mode by an electrostatic coupling. Additionally, the detection electrodes 3, 3 detect the electrical vibration of the vibrating unit 1 by the electrostatic coupling and then output this detected signal to a detector 3a. Here, the center O of the vibrating unit 1 and nodal points at the four points (nodes) n do not vibrate.

The disclosure relates to a transverse cross-sectional shape of the supporting structure, which supports the center O of the vibrating unit 1 where vibration does not occur during operation.

The disk-shaped vibrating unit 1 made of an elastic body, which is employed in the disclosure, is comprised of a monocrystalline silicon or a polycrystalline silicon.

With the MEMS resonator R according to the disclosure, to verify a relationship between the transverse cross-sectional shape of each supporting structure and a resonance frequency, and a relationship between the transverse cross-sectional shape of each supporting structure and a relative value of a Q factor, the center O of the disk 1 is a supported by the supporting structure 1a assuming the following values. The disk 1 illustrated in FIG. 1 has a diameter d of 64 μm and a thickness t of 2 μm. The drive electrodes 2, which are disposed opposite to one another, each have a width w of 40 μm.

Additionally, as listed in Table 1, assume that the supporting structure 1a has a transverse cross-sectional shape of a square shape, a cross shape, a rectangular shape, and an oval shape where the four corners of the rectangular shape is rounded, and the drive electrodes 2, 2 are disposed symmetrically with respect to the Y-axis on the X-Y plane as illustrated in FIG. 1. The transverse cross-sectional shape where each side of the supporting structure with the square shape, the cross shape, the rectangular shape, or the oval shape is constituted to rotate in the Z-axis direction such that an inner angle to the X-axis becomes 45° was selected and employed as the supporting structure. And, each corner portion of the transverse cross-sectional shape of the square shape, the cross shape, and the rectangular shape of the supporting structure may be rounded.

[Table 1]

### Test Example

The cross-sectional shape, the resonance frequency characteristics, and the Q factor relative values of each supporting structure body of the disk type MEMS resonator of the present disclosure are compared with the conventional (the circular shape model) disk type MEMS resonator Furthermore, the five categories of MEMS resonators that were made are listed in Table 2. In these five categories of MEMS resonators, “a” dimensions, in which a circumscribed circle of each cross-sectional shape of the supporting structure 1a almost matches the circular cross-sectional shape of the referenced conventional supporting structure, is incremented from 1 μm to 5 μm by 1 μm at a time. Then, influences caused by a shift of the respective “a” dimensions were verified as follows. Resonance frequencies (kHz) corresponding to these “a” dimensions were measured. Additionally, Q factors (Quality Factors) when the shift (the variation) of the “a” dimensions of the cross-sectional shape of each supporting structure 4a is 3 μm were measured. Using the conventional circular cross section as the model for comparison, merits and demerits of the cross-sectional shapes of the respective supporting bodies were verified.

TABLE 2
“a” dimensions of the cross-sectional shape of each supporting structure and
a resonance frequency

| | | Resonance frequency: kHz | | | | | | |
|---|---|---|---|---|---|---|---|---|
| | | Circular | | | | | | |
| | | shape | Square | Square | Cross | Cross | Rectangular | Rectangular |
| | | model | shape | shape | shape | shape | shape | shape |
| | | (reference) | (0°) | (45°) | (0°) | (45°) | (0°) | (45°) |
| “a” | 1 | 53,265 | 58,266 | 58,266 | 58,264 | 58,264 | 58,264 | 58,264 |
| dimensions | 2 | 58,256 | 58,259 | 58,259 | 58,255 | 58,255 | 58,259 | 58,259 |
| [μm] | 3 | 58,231 | 58,245 | 58,246 | 58,241 | 58,242 | 58,251 | 58,253 |
| | 4 | 58,187 | 58,220 | 58,220 | 58,220 | 58,225 | 58,240 | 58,244 |
| | 5 | 58,118 | 58,182 | 58,185 | 58,191 | 58,203 | 58,226 | 58,232 |

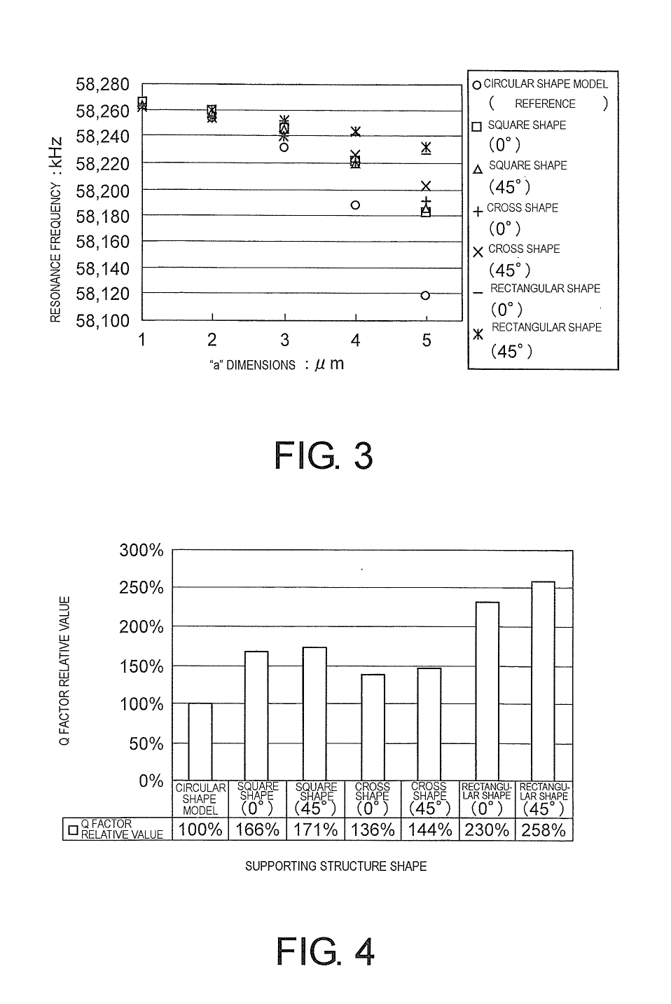

FIG. 3 is a graph where the X-axis indicates “a” dimensions of respective supporting structures illustrated in Table 1 while the Y-axis indicates resonance frequencies, and illustrates a plot of the measured resonance frequencies, which are illustrated in Table 2, on the Y-axis for each transverse cross-sectional shape. FIG. 3 verifies that a variation amount of the resonance frequency relative to a variation of “a” dimensions is smaller in the supporting structure 1a with the non-circular cross-sectional shape (the square shape, the cross shape, the rectangular shape, and the oval (the ellipse) shape) than a variation amount of the supporting structure 1a with a circular cross-sectional shape (the conventional example). Especially, FIG. 3 verifies that the variation amount is the smallest in the case where the transverse cross-sectional shape is the square shape. Additionally, comparing the same transverse cross-sectional shapes, FIG. 3 verifies that the variation amount of the resonance frequency relative to the variation in the “a” dimensions is small in a case where the supporting structure of the cross-sectional shape is rotated at an angle of 45° in the Z-axis direction.

FIG. 4 illustrates a relative value of a Q factor of a resonator that has the supporting structure with each cross-sectional shape when the Q factor of the MEMS resonator (the conventional example) that has the supporting structure with the transverse cross-sectional shape of a circular shape (the circular shape model) is 100% and the “a” dimensions listed in Table 2 is 3 μm (the medium value is 1 μm to 5 μm) for each.

As seen from FIG. 4, it was demonstrated that a Q factor of the supporting structure with the transverse cross-sectional shape of the non-circular shape (the square shape, the cross shape, the rectangular shape, and the oval (the ellipse) shape) is larger than that of the supporting structure with the transverse cross-sectional shape of the circular shape (the conventional example).

From the above-described test examples, it is verified that the supporting structure with the transverse cross-sectional shape of the non-circular cross-sectional shape, for example, any of the square shape, the cross shape, the rectangular shape, and the oval shape, has a small variation of the resonance frequency relative to the shift of the “a” dimension accuracy (the variation) and a large Q factor, compared with the supporting structure with the transverse cross-sectional shape of the circular shape (the conventional example).

In view of these, with the disk type MEMS resonator according to the disclosure, the disk type MEMS resonator that has a smaller variation amount of the resonance frequency and a larger Q factor than the conventional disk type MEMS resonator with the supporting structure of the circular transverse cross-sectional shape can be offered.

### Method for Fabricating the Disk Type MEMS Resonator

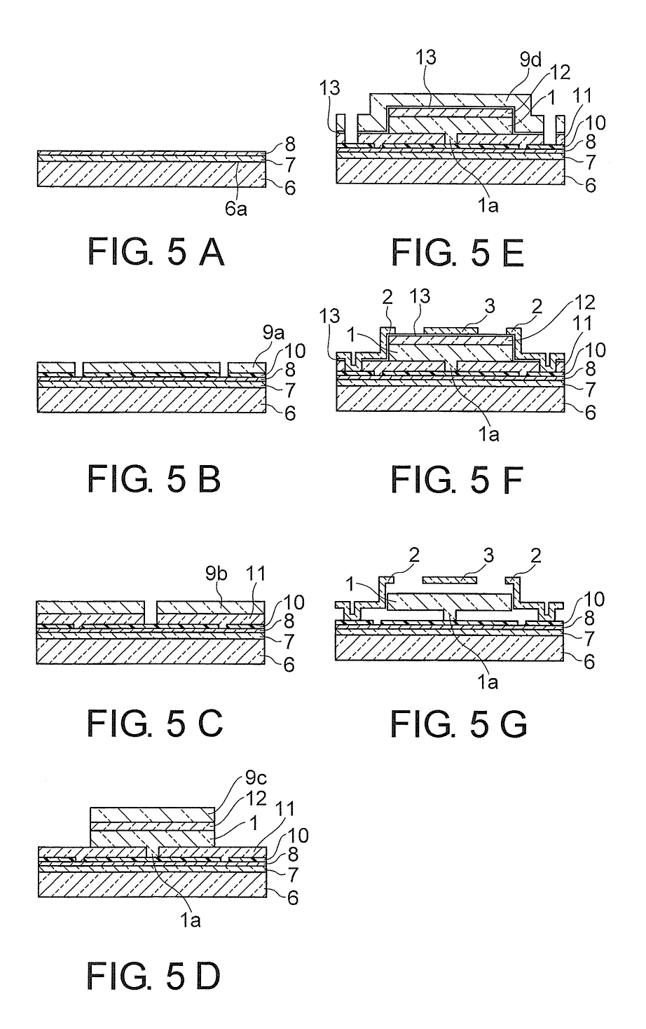

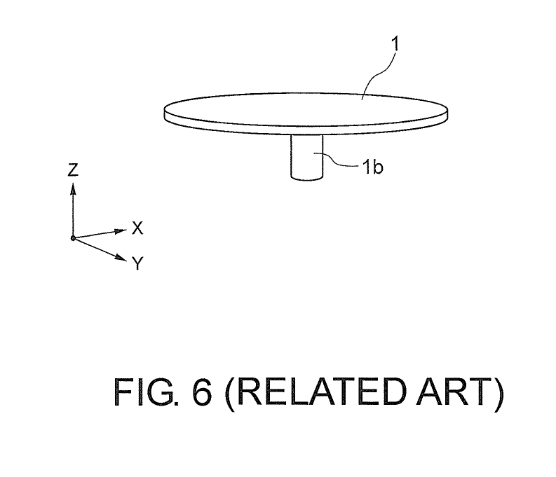

Next, a description will be given of a method for fabricating the disk type MEMS resonator by MEMS according to the disclosure based on process views illustrated in FIGS. 5A to 5G.

First, as illustrated in FIG. 5A, a semiconductor substrate 6 made of Si is prepared. A first insulating film 7, which is made of phosphosilicate glass (PSG) or similar material, is formed on a surface 6a of the semiconductor substrate 6. Then, a second insulating film 8 made of a silicon nitride or similar material is formed on the surface of this first insulating film 7 by a method such as CVD (Chemical Vapor Deposition) or sputtering.

Next, as illustrated in FIG. 5B, a conducting layer 10 is formed on the surface of the second insulating film 8 by a method such as CVD or sputtering. The conducting layer 10 is made of a polysilicon film (Doped poly-Si) or similar material where phosphorus or boron is doped for adding a conductive property. Then, patterning with a patterning process that includes a formation process of a patterning mask and an etching process using this patterning mask is performed. The patterning mask is formed by application of a resist 9a, exposure, and development. Thus, portions on which the respective pairs of drive electrodes 2 and detection electrodes 3 in predetermined shapes as illustrated in FIG. 1 are to be disposed remain.

Further, as illustrated in FIG. 5C, a sacrifice layer 11 made of a PSG or similar material is formed on the surface of the conducting layer 10 by a method such as CVD or sputtering. A patterning process, such as application of a resist 9b, is performed similarity to the method illustrated in the above-described FIG. 5B. A part of the sacrifice layer 11 where the supporting structure 1a is to be positioned on the vibrating unit (the disk) 1 of the MEMS resonator illustrated in FIG. 1 is removed by etching. And, in this process, the surface (the top surface) of the sacrifice layer 11 may be flattened by a method such as chemical mechanical polishing (CMP). A peeling process of a resist 9b is performed together.

Further, as illustrated in FIG. 5D, a conducting layer made of a material such as a doped polysilicon film is formed on the sacrifice layer 11 by a method such as CVD or sputtering. An oxidized film 12 made of a material such as non-doped-silicate-glass (NSG) is formed on the surface (the top surface) of a resonator structure formation layer 1 by a method such as CVD or sputtering. Then, the patterning process similar to the above-described process, such as an application of a resist 9c, is performed to form a disk-shaped resonator structure 1 including the supporting structure 1a (see FIG. 1). In this process, the surface (the top surface) of the conductive film 1 is flattened by a method such as chemical mechanical polishing (CMP). A peeling process of a resist 9c is performed together.

Next, as illustrated in FIG. 5E, an oxidized film 13 made of non-doped-silicate-glass (NSG) is formed on the surface (the top surface) of the resonator structure formation layer 1, which was formed in the previous process, by a method such as CVD or sputtering. Then, the patterning process similar to the above-described process, such as an application of a resist 9d, is performed. A peeling process of a resist 9d is performed together.

Further, as illustrated in FIG. 5F, other conducting layers 2, 3, which are made of a doped polysilicon film, are formed on a trace from which the resist 9d was detached in the process illustrated in FIG. 5E by a method such as CVD or sputtering. The patterning process similar to the above-described process is performed to form the drive electrode 2 and detection electrode 3.

Finally, as illustrated in FIG. 5G, the sacrifice layer 11, and the oxidized films 12, 13 are removed by an etching process using hydrofluoric acid-based etchant or similar methods. This separates the outer periphery portion of the resonator structure 1 (the disk) from the drive electrodes 2 and the detection electrodes 3 with a predetermined gap g. Then, the bottom surface of the resonator structure formation layer 1 (the disk) is separated from the semiconductor substrate 6, thus fabricating a resonator structure R (a disk type MEMS resonator).

### INDUSTRIAL APPLICABILITY

A disk type MEMS resonator according to the disclosure is widely applicable to a device such as a resonator, a SAW (Surface Acoustic Wave) device, a sensor, and an actuator.

1. A disk type resonator, which is an electrostatic drive disk type MEMS resonator, comprising:
a disk type vibrating unit;
drive electrodes disposed opposite to one another, the drive electrodes being disposed at both sides of the vibrating unit having a predetermined gap with respect to an outer peripheral portion of the disk type vibrating unit;
a unit configured to apply an alternating current bias voltage with a same phase to the drive electrodes; and
a detection unit configured to obtain an output corresponding to an electrostatic capacitance between the disk type vibrating unit and the drive electrodes, wherein
the disk type vibrating unit is supported by a pillar-shaped supporting structure,
the supporting structure is disposed upright at the center of the disk, and
the supporting structure has a transverse cross-sectional shape of a non-circular shape.

2. The disk type resonator according to claim 1, wherein
the supporting structure has the transverse cross-sectional shape of the non-circular shape that is a square shape, a cross shape, a rectangular shape, or an oval shape.

3. The disk type resonator according to claim 2, wherein
the supporting structure has the transverse cross-sectional shape of the square shape, the cross shape, or the rectangular shape, and
the transverse cross-sectional shape has respective rounded corner portions.

4. The disk type resonator according to claim 2, wherein
the drive electrodes are disposed symmetrically with respect to the Y-axis on the X-Y plane; and
each side of the supporting structure with the transverse cross-sectional shape is constituted to rotate in the Z-axis direction such that an inner angle to the X-axis and the Y-axis becomes 45°.

5-6. (canceled)

7. The disk type resonator according to claim 1, wherein
the vibrating unit is made of a monocrystalline silicon or a polycrystalline silicon.

8. The disk type resonator according to claim 2, wherein
the vibrating unit is made of a monocrystalline silicon or a polycrystalline silicon.

9. The disk type resonator according to claim 3, wherein
the vibrating unit is made of a monocrystalline silicon or a polycrystalline silicon.

10. The disk type resonator according to claim 4, wherein
the vibrating unit is made of a monocrystalline silicon or a polycrystalline silicon.

11. The disk type resonator according to claim 1, wherein
the disk type MEMS resonator is fabricated by MEMS.

12. The disk type resonator according to claim 2, wherein
the disk type MEMS resonator is fabricated by MEMS.

13. The disk type resonator according to claim 3, wherein
the disk type MEMS resonator is fabricated by MEMS.

14. The disk type resonator according to claim 4, wherein
the disk type MEMS resonator is fabricated by MEMS.

15. The disk type resonator according to claim 7, wherein
the disk type MEMS resonator is fabricated by MEMS.

16. The disk type resonator according to claim 8, wherein
the disk type MEMS resonator is fabricated by MEMS.

17. The disk type resonator according to claim 9, wherein
the disk type MEMS resonator is fabricated by MEMS.

18. The disk type resonator according to claim 10, wherein
the disk type MEMS resonator is fabricated by MEMS.
